(19) United States
(12) Patent Application Publication
(10) Pub. No.: US 2006/0090069 A1
(43) Pub. Date: Apr. 27, 2006

(54) Method and system for caching read requests from a shared image in a computer network

(75) Inventors: Gintautas Burokas, Orland Park, IL (US); Jeffrey Achesinski, Virginia Beach, VA (US); Ted Davis, Norfolk, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Venturcom, Inc., Waltham, MA (US)

(21) Appl. No.: 10/971,563

(22) Filed: Oct. 22, 2004

(51) Int. Cl. H04L 9/00

(52) U.S. Cl. 713/163

(57) ABSTRACT

A shared image stored in a server is shared by a plurality of clients. The shared image includes data that may be downloaded over a computer network to each of the clients. To conserve network bandwidth when downloading the data, upon receiving a request from one of the clients to download the data, the server multicasts the data to all of the clients sharing the shared image.

### BACKGROUND OF THE INVENTION

In a client-server system, client computers and server computers communicate over a computer network. In order to off-load processing from the server and to reduce traffic on the computer network, each client typically has persistent storage such as a hard disk drive for storing an operating system and application programs that are executed locally in the client computer.

However, in many environments, for example, in a classroom environment, the cost of managing and updating individual copies of the operating system and application programs on each client computer is expensive. One approach to reducing the cost of managing a network of client computers is through the use of “thin” clients. Instead of executing an application program locally, a thin client transmits keystrokes over the computer network to an application program that executes on a server and displays results received over the computer network from the execution of the application on the server. As processing for many clients is performed in the server and transmitted over the computer network, this results in significant performance degradation.

Another approach is the use of “diskless” clients. A copy of the operating system is stored in a server computer. When first turned on, an operating system loader stored in firmware that is stored in non-volatile memory in the client remotely loads the required operating system components that are stored in the server into the client's volatile memory using a standard boot protocol. After the operating system has been loaded, the client accesses the operating system as if it were stored on a local disk. After the operating system is running, the client requests further download of other data such as, application programs, operating system or application data, and additional operating system components stored in the server, as needed, and retains that data in volatile memory. Thus, each client only requires sufficient persistent (non-volatile) storage to store the operating system loader.

### SUMMARY OF THE INVENTION

The diskless client executes the operating system as if it were stored on a local disk and requests access to application programs and data, also expecting them to be stored locally on the disk. The networked computer system may include hundreds of diskless clients all requesting data from a shared image. As each request to the read image data requires computer network bandwidth, the response time prior to responding to an access from a client to read data may be longer than for a locally stored read data dependent on the number of requests in progress.

In some environments, a majority of the clients may all require the same data to be read. For example, in a classroom, all of the students may be launching a word processing application program and will therefore all need to read data that includes the application program and its configuration information. Computer network bandwidth and server CPU load for accessing data from a shared image on a server is decreased by multicasting the data to all clients sharing the image upon receiving the first request for the data.

A method of sharing images in a computer network is provided. A shared image is provided on a server. Clients request data from the saved shared image file on the server. Upon receiving a request for data from a client, the server multicasts the data to all clients sharing the image file. Multicast data is cached locally by other clients with the expectation that they will soon also need the same data.

The data may be from an application program, operating system, application data, image or a database. The multicasted data is stored in cache memory in each of the clients and a subsequent request for the data from one of the clients may already have and can retrieve the multicasted data stored in the client's local cache. Over time, each client accumulates data that is accessed by other similar clients effectively anticipating that it will also need the data.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating a shared image stored in a server, the shared image includes data (for example, an operating system, data and application programs) that is accessed by clients over a computer network according to the principles of the present invention;

FIG. 2 is a block diagram illustrating software components stored in memory in the client after the operating system has been loaded and is executing (running);

FIG. 3 is a flow chart illustrating a method implemented in the client for accessing data in the shared image; and

FIG. 4 is a flow chart illustrating a method implemented in the server for accessing data residing in the shared image in the server over the computer network to one or more clients sharing the shared image.

### DETAILED DESCRIPTION OF THE INVENTION

A description of preferred embodiments of the invention follows.

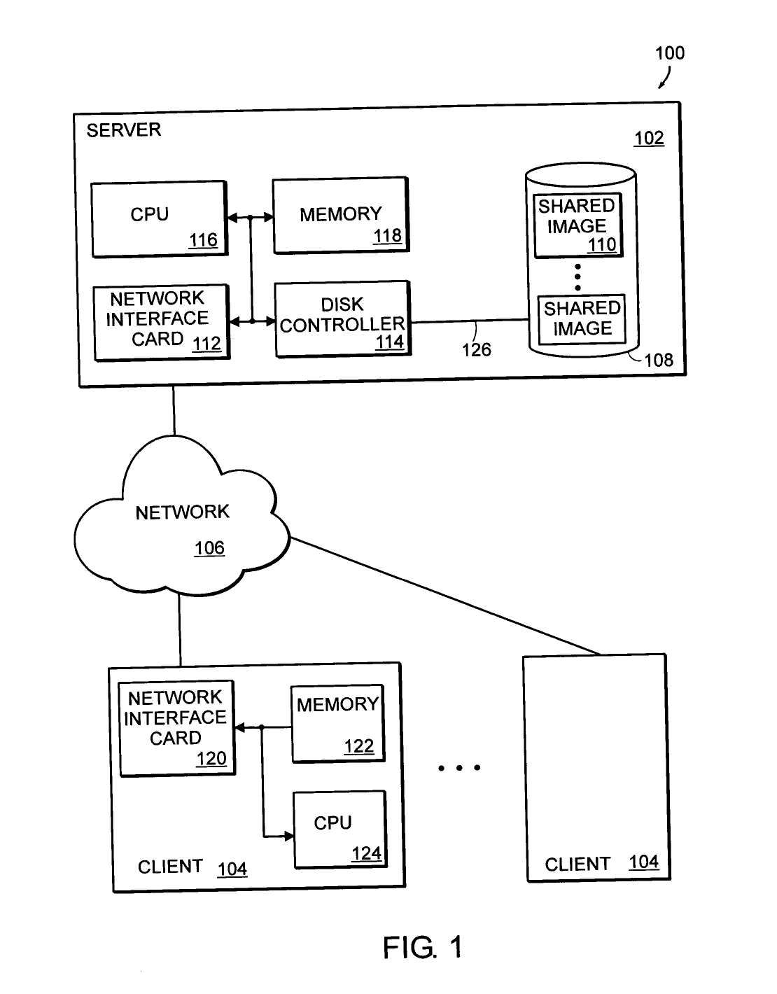

FIG. 1 is a block diagram illustrating a shared image 110 stored in a server 102. The shared image 110 includes data (for example, an operating system, operating system and application data and application programs) that is accessed by clients over a computer network according to the principles of the present invention.

A client-server system 100 includes at least one server computer 102 and a plurality of client computers 104 that communicate over a computer network 106. The clients and servers transfer data over the network 106 using standard communication protocols well-known to those skilled in the art such as TCP/IP, with data transmitted over the network 106 in the form of packets. In a packet switching network, a packet is a transmission unit of a fixed maximum size that includes binary digits representing both data and a header, the header containing an identification number and source and destination addresses. The computer network 106 includes one or more network router/switches for forwarding data between clients 104 and servers 102. The physical links between the clients and servers can include wireless or wired links.

One or more Network Interface Controllers (NIC) in each of the server 102 and the client 104 controls transfer of data over the network 106. Each NIC 120, 112 stores a unique data link (Layer 2) destination address in nonvolatile memory that is used to identify the destination of a data packet on the network. The nonvolatile memory can be ROM or Flash memory or any other nonvolatile memory. In one embodiment, the data link protocol is Ethernet. However, any other data link protocol can be used.

The server 102 includes a Central Processing Unit (CPU) 116, memory 118 and persistent storage 108 such as a hard disk drive or compact disk drive that stores one or more shared images 110. Each shared image 110 includes an operating system, drivers and application programs for use by one or more clients 104. The memory 118 can include Read Only Memory (ROM) and Random Access Memory (RAM).

The server 102 also includes a disk controller 114 that controls access to the disk drive 108 over a storage bus 126. In one embodiment, the disk controller 114 is a Small Computer System Interface (SCSI) host adapter that controls access to devices coupled to a standard SCSI bus. SCSI host adapters are well-known to those skilled in the art. In one embodiment, more than one server 102 can be connected to the network 106 and communicate with all of the other servers and clients 104 over the network 106.

Each client 104 also includes a CPU 124 and volatile and non-volatile memory 122. The client operates without significant persistent storage devices, for example, a hard disk, bootable compact disk or large flash memory.

As is well-known to those skilled in the art, a hard disk includes a plurality of cylinders, heads and sectors. A physical block on the disk is specified by a cylinder, head and sector number. The head specifies a track within the cylinder of tracks. The sector specifies the location of a physical block of data within the specified track. In response to a request to write or read data to cylinder, head and sector, the drive steps a head actuator to the cylinder location and selects the appropriate head. Thus, the cylinder, head, sector (CHS) address specifies a physical sector on the drive. The physical sector is the smallest physical storage unit on the disk drive and is a fixed size, typically 512 bytes. A request to read data is translated by the operating system into a request to read data stored in one or more physical sectors on the disk drive.

Instead of accessing data directly sector-by-sector from a hard disk, the client 102 executes an operating system and application programs that are read on-demand sector-by-sector from the shared image on the server and are loaded locally in the client's volatile memory 122 just as if they would be read from a local disk.

Multiple clients can share a shared image 110 on the server 102. The operating system, drivers and application programs are read from the shared image 110 by clients 104, on demand. The clients 104 access the locally cached operating system, drivers and application programs from the shared image 110 that are stored in its internal memory 122, as if they were stored locally on its local hard drive.

The server's operating system uses a portion of memory 118 as cache memory for storing data read from the disk drive 108. Thus, portions of the shared image 110 can be stored locally in the cache memory in the server 102 to improve performance in downloading data from the shared image to one or more clients.

After power-up, the server boots an operating system stored in its disk drive 108 and waits for access from clients 104 for data stored in the shared images 110. A portion of the memory 122 in the client 102 is nonvolatile memory, for example, Read Only Memory (ROM) or Flash memory used for storing a BIOS (Basic Input/Output System) that is executed when the computer is initially powered on. The BIOS includes a set of software routines executed by the client's CPU 124 for testing the hardware and a set of software routines to initiate a boot loader to load an operating system.

In one embodiment, the NIC 120 in the client includes Pre-Boot EXecution (PXE) emulation code. The PXE protocol is an international standard protocol for network booting a computer. PXE establishes a common and consistent set of services that can be employed by the BIOS in the client to boot the operating system stored in the server 104 over the network 106. The PXE protocol uses Dynamic Host Configuration and Trivial File Transfer Protocol (TFTP) to communicate with the server 104. The Dynamic Host Configuration Protocol (DHCP) is a standard boot protocol defined by Internet Engineering Task Force (IETF) Request for Comments (RFC) 2131 available on the Internet at www.ietf.org. Alternatively, BOOTP enabled clients with a static IP address can also be used instead of DHCP and PXE. BOOTP is a standard protocol defined by Internet Engineering Task Force (IETF) Request for Comments (RFC) 951 available at www.ietf.org.

The Operating System is loaded on demand into memory 122 in the client 104, as data stored in a sector is needed from the shared image 110. The operating system is stored in the client's memory and accessed in a manner identical to how it would be accessed when read directly sector-by-sector from a local hard. To conserve bandwidth, one or more sectors of data are multicast or broadcast to all clients sharing the shared image 110 in response to a read request from a single client. After the operating system is booted and is running in memory in the client, the client can request other data from the shared image 110, for example, application programs, images, text files, video, databases, or any other type of data.

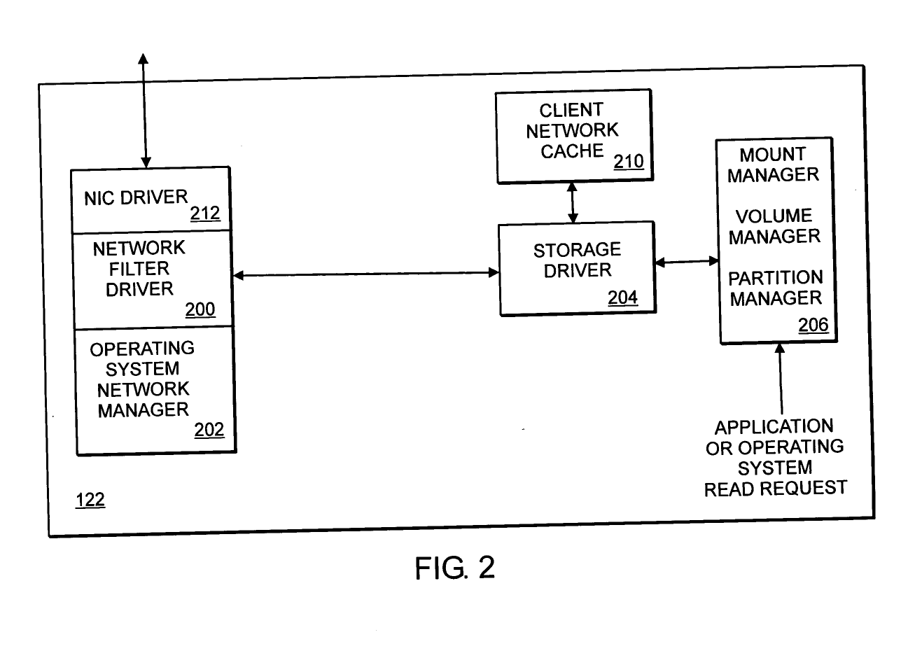

FIG. 2 is a block diagram illustrating software components stored in memory in the client 104 after the operating system has been loaded. A network filter driver 200 monitors all packets received over the network 106 through the NIC 120 for packets that are specific to accesses to data in the shared image 110. The network filter driver 200 passes these packets to a storage driver 204. The storage driver 204 determines if the read request data is a direct request by the client and/or whether this data should be stored in the client network cache 210 for further use. The storage driver 204 communicates with operating system storage managers 206 that include a mount manager, volume manager and partition manager. Any packets that are not specific to files in the shared image are handled by the operating system network manager 202. For example, any packets related to electronic mail, web pages and instant messaging are directed to the operating system network manager 202.

After the operating system has been loaded on a client, each client can initiate a request for other data stored in the shared image such as, an application program. In one embodiment, there may be hundreds of clients, all of which will request download of the same data. Each client that shares the shared image will issue a separate request for the same data.

If one member of the group requests the computer program, it is likely that other clients sharing the shared image 110 will also request the same computer program in the future. Thus, a multicast group is created for all clients that share a shared image 110. Clients that share the shared image 110 are members of the multicast group. Instead of responding to a read request from a client by unicasting the data to only the requesting client, the server multicasts the read response to all members of the multicast group that share the shared image 110 on the server 102 based on an assumption that the other clients will soon require the same data.

By multicasting the requested data to all members of the multicast group, only a single copy of the requested data is transmitted from the server 106 over the computer network and is delivered to all members of the multicast group. This reduces the network bandwidth that would have been used to send multiple copies of the same data where each copy is sent in response to a separate request from a client. Furthermore, due to the reduction in requests from clients to download the same data, the available CPU bandwidth in the server is increased.

Upon receiving a read request from an application or operating system executing on the client computer, the file system in the operating system on the client computer directs the storage driver 204 to locate requested data and read the requested data into the client's memory 122 so that it can be loaded.

Data from the shared image that has been read by other clients is already stored in this client's network cache 210 in the client's memory 122. If the data is not already stored in the client network cache 210, the storage driver 204 redirects the request for the read request received from the file system interface to the network filter driver 200 to request data from the shared image 110 stored in the server 104.

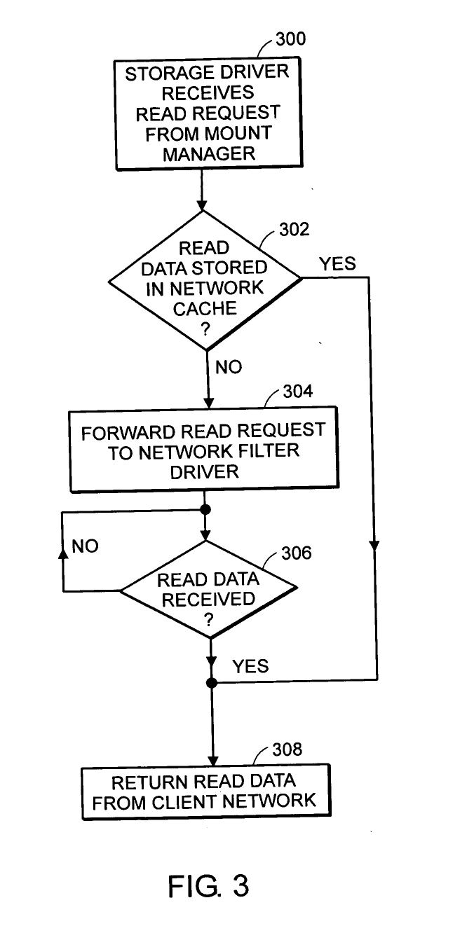

FIG. 3 is a flow chart illustrating a method implemented in the client for requesting access to network cacheable data in the shared image. FIG. 3 is described in conjunction with FIG. 2.

At step 300, a read request for data is received by the storage driver 204 from the mount manager 206.

At step 302, the storage driver 204 checks if the data is already stored in a pre-allocated area of memory, referred to as “client network cache” 210. If the requested data is already stored in client network cache 210, processing continues with step 308. If not, processing continues with step 304.

At step 304, the data has not previously been read from the shared image 110, the storage driver 204 issues a read request via the network filter driver 200 to forward the read request to the server 104 via the Network Interface Controller driver 212. The Network Interface Controller driver 212 forwards the read request to the server 104 over the computer network 106 to retrieve the requested data from the shared image 110.

At step 306, the storage driver 204 waits for the completion of the request for data. The requested data arrives through the NIC 112 and is stored in client network cache 210 by the network filter driver 200.

At step 308, the storage driver 204 informs the mount manager 206 that the requested data is available and is stored in the client network cache 210.

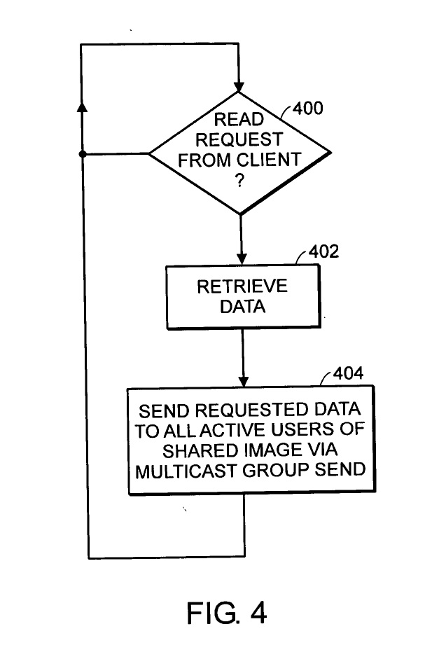

FIG. 4 is a flow chart for the server illustrating the method for retrieving data from a shared image 110 in the server 102 over a computer network 106 for one or more clients sharing the shared image 110.

At step 400, the server 102 receives a request from a client 104 to retrieve data stored in a shared image 110. Upon receiving the request, instead of unicasting the application program to the requester, the server prepares to send the application program to all clients 104 sharing the shared image 110.

Internet Protocol (IP) Multicast is a one-to-many connection. Multiple clients, that is, members of a multicast group, receive the same data stream from a server. A single data packet identified by a single IP destination group address is sent to a multicast group, instead of sending individual data packets to each destination.

The members of this particular Multicast group are users of a specific shared image 110 that are currently using the shared image 110. The members of the multicast group change as users connect and disconnect from the server 104. Typically, the shared image 110 is pre-established and fixed as read only at boot time. Thus, all users connected to the server that use the shared image 110 are members of the same multicast group and only read data from the shared image 110.

At step 404, the server 104 multicasts the requested data to all members of the IP Multicast group. By multicasting to a plurality of clients instead of unicasting a separate copy of the data in response to a separate request from each client, the network bandwidth used for sending data from a shared image to diskless clients is reduced. The first client to request the data will not perceive a delay due to the Multicast send operation as there is no significant penalty in multicasting the response in contrast to unicasting the response. Subsequent requests for the same data by all clients sharing the shared image 110 will be fast because the network cached data will already be stored in each client network cache 210.

In one embodiment, the NIC 112, 120 in the server 102 and the client 104 communicate using the User Datagram Protocol (UDP). As is well-known to those skilled in the art, the Open Systems Interconnection (OSI) Reference Model defines seven network protocol layers (L1-L7) used to communicate over a transmission medium. The upper layers (L4-L7) represent end-to-end communications and the lower layers (L1-L3) represent local communications. UDP is a transport layer (L3) protocol.

The transport layer of the OSI model handles end-to-end transport between the source and the destination of the packet. UDP passes individual packets to IP (layer 3 of the OSI model) for transmission.

However, the invention is not limited to UDP. The communications network can use any communication protocol that allows data to be multicast to members of a multicast group. In an alternate embodiment, the communications protocol can be the fibre channel protocol.

The downloaded application program stored in the client network cache 210 is executed locally using the local processing power of the client. This allows the client to work efficiently as compared to alternative solutions such as thin-clients with all processing performed in the server, resulting in significant performance degradation.

The invention has been described for an embodiment in which data from an application program is downloaded from the shared image file on the server. However, the invention is not limited to downloading an application program. It applies to any request by a client for any data stored in the shared image file. The requested data can be from an operating system, a database, an application program, an image, a video, a text file or any other type of data that is stored in the shared image file.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of sharing images in a computer network comprising:
providing a shared image file on a server;
from clients, requesting data from the shared image file on the server; and
upon receiving a request for data from a client, multicasting from the server the data to all clients sharing the image file.

2. The method of claim 1, wherein the data is from an application program.

3. The method of claim 1, wherein the data is from an operating system.

4. The method of claim 1, wherein the data from a database.

5. The method of claim 1, wherein the data is from an image.

6. The method of claim 1, further comprising:
storing the multicasted data in each of the clients.

7. The method of claim 6, wherein a subsequent request for the data from one of the clients retrieves the multicasted data stored in the client.

8. A computer comprising:
a persistent storage device storing a shared image file;
a routine stored in memory which upon receiving a request from a client over a computer network for data from the shared image file, multicasts the data over a computer network to all clients sharing the image file.

9. The computer of claim 8, wherein the data is from an application program.

10. The computer of claim 8, wherein the data is from an operating system.

11. The computer of claim 8, wherein the data is from a database.

12. The computer of claim 8, wherein the data is from an image.

13. A system comprising:
a client computer comprising:
memory for storing data from the shared image file, upon receiving a request for data from a client over a computer network; and
a server computer comprising,:
a persistent storage device storing a shared image file; and
memory storing a routine for multicasting data from the shared image, the routine multicasts the data over a computer network to all clients sharing the image file.

14. The system of claim 13, wherein the data is from an application program.

15. The system of claim 13, wherein the data is from an operating system.

16. The system of claim 13, wherein the persistent storage in the server is a hard drive.

17. The system of claim 13, wherein the multicasted data in stored in volatile memory in each of the clients.

18. The system of claim 13, wherein a subsequent request for the data from one of the clients retrieves the multicasted data stored in volatile memory in the client.

19. A system for sharing images in a computer network comprising:
means for providing a shared image file on a server;
means on clients for requesting data from the saved image file on the server; and
upon receiving a request for data from a client, means for multicasting from the server the data to all clients sharing the image file.
